(19) United States
(12) Patent Application Publication
(10) Pub. No.: US 2015/0307402 A1
(43) Pub. Date: Oct. 29, 2015

(54) Ceramic Casing Structural Part and Preparing Method Thereof

(71) Applicant: Huawei Technologies Co., Ltd., Shenzhen (CN)

(72) Inventor: Ming Cai, Shenzhen (CN)

(21) Appl. No.: 14/793,388

(22) Filed: Jul. 7, 2015

Related U.S. Application Data
(63) Continuation of application No. PCT/CN2013/085589, filed on Oct. 21, 2013.

(30) Foreign Application Priority Data
Mar. 25, 2013 (CN) 201310097316.2

(51) Int. Cl. C04B 35/00; B02C 23/18; C04B 35/64; B02C 15/00

(52) U.S. Cl. CPC C04B 35/00; B02C 15/00; B02C 23/18; C04B 35/64

(57) ABSTRACT

A ceramic casing structural part, including a ceramic casing and a frame, where the ceramic casing includes a ceramic flat plate and a ceramic projection that is partially embedded in the ceramic flat plate, the frame abuts the ceramic flat plate along a thickness direction of the ceramic flat plate by using the ceramic projection, an upper surface and a lower surface of the frame are respectively level with an upper surface and a lower surface of the ceramic casing. The frame can protect an edge of the ceramic casing from a direct collision with another object, and the ceramic projection can increase a binding force between the ceramic casing and the frame, thereby improving an overall drop-resistant capability of the ceramic casing structural part in the present invention.

### CROSS-REFERENCE TO RELATED APPLICATIONS

This application is a continuation of International Application No. PCT/CN2013/085589, filed on Oct. 21, 2013, which claims priority to Chinese Patent Application No. 201310097316.2, filed on Mar. 25, 2013, both of which are hereby incorporated by reference in their entireties.

### TECHNICAL FIELD

The present invention relates to ceramic product structures, and in particular, to a ceramic casing structural part and a preparing method thereof.

### BACKGROUND

With rapid development of digital products such as smartphones, research and development of structural materials with unique characteristics for digital products becomes an important direction to preempt a selling point in business. Ceramic, as a type of commonly used structural material, has drawn attention of the industry. It is understandable that a casing material needs to have proper drop-resistant performance, and should also be low-cost and easy to prepare. However, due to its great brittleness, a ceramic material is easy to be damaged when colliding with another object, and this disadvantage restricts application of the ceramic material as a casing.

### SUMMARY

In view of this, a first aspect of embodiments of the present invention provides a ceramic casing structural part, which is used to resolve a problem in the prior art that a ceramic casing is not drop-resistant. A second aspect of the embodiments of the present invention provides a method for preparing a ceramic casing structural part.

According to the first aspect, an embodiment of the present invention provides a ceramic casing structural part, including a ceramic casing and a frame group, where the ceramic casing includes a ceramic flat plate and a ceramic projection that is partially embedded in the ceramic flat plate, the frame abuts the ceramic flat plate along a thickness direction of the ceramic flat plate by using the ceramic projection, an upper surface and a lower surface of the frame are respectively level with an upper surface and a lower surface of the ceramic casing, a material of the ceramic flat plate is a dense ceramic material with a density higher than 90%, a material of the ceramic projection is a porous ceramic material, and a material of the frame is an alloy, a metal-based composite material, or plastic.

Preferably, a porosity of the porous ceramic material is 20-60%, and a pore size is 1-1200 microns.

Preferably, the dense ceramic material is an aluminum oxide-based ceramic or a zirconium oxide-based ceramic, where a grain size of the aluminum oxide and the zirconium oxide is of a micron scale or a nanometer scale.

Preferably, the porous ceramic material is an aluminum oxide-based ceramic or a zirconium oxide-based ceramic, where a grain size of the aluminum oxide and the zirconium oxide is of a micron scale or a nanometer scale.

Preferably, the ceramic projection is partially embedded in the frame.

The first aspect of the embodiment of the present invention provides a ceramic casing structural part, which includes a ceramic casing and a frame. The frame can protect an edge of the ceramic casing from a direct collision with another object, thereby reducing a probability of breakage of the ceramic casing due to a collision with another hard object. A ceramic projection in the ceramic casing is of a porous ceramic material with a high porosity, and can increase a binding force between the ceramic casing and the frame, thereby improving an overall drop-resistant capability of the ceramic casing structural part in the present invention, and expanding an application scope of the ceramic casing structural part.

According to the second aspect, an embodiment of the present invention provides a method for preparing a ceramic casing structural part, including taking ceramic powder, and performing ball-milling to prepare dense ceramic slurry; taking more ceramic powder, adding a pore-forming agent, and performing ball-milling to prepare porous ceramic slurry; separately drying and then graining the dense ceramic slurry and the porous ceramic slurry, and filling them respectively into a groove in a ceramic casing die corresponding to a ceramic flat plate and a groove in the ceramic casing die corresponding to a ceramic projection to mold them into a ceramic embryo; and then sintering the obtained ceramic embryo to prepare a ceramic casing, where the ceramic casing includes a ceramic flat plate of a dense ceramic material with a density higher than 90% and a ceramic projection of a porous ceramic material, where the ceramic projection is partially embedded in the ceramic flat plate; and taking raw materials of a frame and the ceramic casing, and preparing the ceramic casing structural part by using an integrated molding method, where the frame abuts the ceramic flat plate along a thickness direction of the ceramic flat plate by using the ceramic projection, an upper surface and a lower surface of the frame are respectively level with an upper surface and a lower surface of the ceramic casing, and a material of the frame is an alloy, a metal-based composite material, or plastic.

Preferably, when the material of the frame is an alloy, the integrated molding method is die-casting molding, and a specific operation is placing the ceramic casing into a die-casting die cavity for the ceramic casing structural part, and performing die-casting molding with a liquid or semi-solid alloy material to obtain the ceramic casing structural part.

Preferably, the pore-forming agent is selected from one or more of the following: carbon dust, graphite, wood flour, coke, paraffin, and molding powder.

Preferably, the pore-forming agent takes up 20-60% of a total volume of the porous ceramic slurry.

Preferably, a main component of the ceramic powder is aluminum oxide or zirconium oxide, where a grain size of the aluminum oxide and the zirconium oxide is of a micron scale or a nanometer scale.

Preferably, the ceramic projection is partially embedded in the frame.

The method for preparing a ceramic casing structural part provided by the second aspect of the embodiment of the present invention is simple and easy to implement, and is suitable for volume production and application.

The following specification partially describes advantages of the embodiments of the present invention, where some of these advantages are apparent according to this specification, or can be learned by practicing the embodiments of the present invention.

### BRIEF DESCRIPTION OF THE DRAWINGS

FIG. 1 is a schematic structural diagram of a ceramic casing structural part prepared in Embodiment 1 of the present invention;

FIG. 2 is a main view of a ceramic casing prepared in Embodiment 1 of the present invention;

FIG. 3 is a right view of the ceramic casing prepared in Embodiment 1 of the present invention;

FIG. 4 is a top view of the ceramic casing prepared in Embodiment 1 of the present invention;

FIG. 5 is a schematic structural diagram of a ceramic casing structural part prepared in Embodiment 2 of the present invention;

FIG. 6 is a main view of a ceramic casing prepared in Embodiment 2 of the present invention;

FIG. 7 is a right view of the ceramic casing prepared in Embodiment 2 of the present invention; and

FIG. 8 is a top view of the ceramic casing prepared in Embodiment 2 of the present invention.

### DETAILED DESCRIPTION

The following descriptions are exemplary implementation manners of the present invention. It should be noted that a person of ordinary skill in the art may make certain improvements and polishing without departing from the principle of the present invention and the improvements and polishing shall fall within the protection scope of the present invention.

A first aspect of embodiments of the present invention provides a ceramic casing structural part, which is used to resolve a problem in the prior art that a ceramic casing is not drop-resistant. A second aspect of the embodiments of the present invention provides a method for preparing a ceramic casing structural part.

According to the first aspect, an embodiment of the present invention provides a ceramic casing structural part, including a ceramic casing and a frame, where the ceramic casing includes a ceramic flat plate and a ceramic projection that is partially embedded in the ceramic flat plate, the frame abuts the ceramic flat plate along a thickness direction of the ceramic flat plate by using the ceramic projection, an upper surface and a lower surface of the frame are respectively level with an upper surface and a lower surface of the ceramic casing, a material of the ceramic flat plate is a dense ceramic material with a density higher than 90%, a material of the ceramic projection is a porous ceramic material, and a material of the frame is an alloy, a metal-based composite material, or plastic.

Preferably, the dense ceramic material is an aluminum oxide-based ceramic or a zirconium oxide-based ceramic, where a grain size of the aluminum oxide and the zirconium oxide is of a micron scale or a nanometer scale.

Preferably, the porous ceramic material is an aluminum oxide-based ceramic or a zirconium oxide-based ceramic, where a grain size of the aluminum oxide and the zirconium oxide is of a micron scale or a nanometer scale.

The ceramic casing is closely combined with the frame, and the two form a complete ceramic casing structural part. A shape of the frame is not limited but depends on an actual demand, and usually includes a bend angle structure. The material of the frame may be an alloy, a metal-based composite material, or plastic. The alloy may be an aluminum alloy, a magnesium alloy, a zinc alloy, or the like, and is preferably an aluminum alloy.

The ceramic flat plate is not limited in shape or thickness, and may be prepared with various shapes according to actual demands for a product. Preferably, the ceramic flat plate is a rectangular flat plate. Upper and lower surfaces of the ceramic flat plate have proper flatness.

A ceramic projection is not limited in shape or position, and may be partially embedded in a position such as a side face or the lower surface that are of the ceramic flat plate and can contact the frame, where the “can contact the frame” includes a part of the ceramic projection that protrudes from the ceramic flat plate may abut the frame or may be partially or entirely embedded in the frame, with a purpose to fill pores with the frame material by taking advantage of a high porosity of a porous ceramic material of the ceramic projection, thereby increasing a binding force between the ceramic flat plate and the frame. It is understandable that, to increase the binding force, the part of a ceramic projection that protrudes from the ceramic flat plate should contact the frame as much as possible. Preferably, the ceramic projection is partially embedded in the frame.

Preferably, the porosity of the porous ceramic material is 20-60%, and a pore size is 1-1200 microns. Porous ceramics, honeycomb ceramics, pore gradient ceramics, and foamed ceramics are all within the definition of the porous ceramic material in this embodiment of the present invention.

The number of disposed ceramic projections is not limited, and may be set to be multiple according to an actual demand, and the ceramic projections may be disposed symmetrically or asymmetrically.

A main component of the dense ceramic material and the porous ceramic material is not limited. Preferably, the dense ceramic material and the porous ceramic material are aluminum oxide-based ceramics or zirconium oxide-based ceramics, where a grain size of the aluminum oxide and the zirconium oxide is of a micron scale or a nanometer scale. The aluminum oxide-based ceramic is a ceramic formed by aluminum oxide mixed with other oxides, and the zirconium oxide-based ceramic is a ceramic formed by zirconium oxide mixed with other oxides, where these other oxides may be selected from but is not limited to yttrium oxide and magnesium oxide, and the material of the ceramic casing may include aluminum oxide and zirconium oxide at the same time.

The ceramic flat plate is not limited in color, and may be white that is mainly aluminum oxide or zirconium oxide, or another color (such as black, blue, or multicolor) formed by adding substances such as impurities or colorants, or a color formed by sintering in a specific atmosphere.

The first aspect of the embodiment of the present invention provides a ceramic casing structural part, which includes a ceramic casing and a frame. The frame can protect an edge of the ceramic casing from a direct collision with another object, thereby reducing a probability of breakage of the ceramic casing due to a collision with another hard object. A ceramic projection in the ceramic casing is of a porous ceramic material with a high porosity, and can increase a binding force between the ceramic casing and the frame, thereby improving an overall drop-resistant capability of the ceramic casing structural part in the present invention, and expanding an application scope of the ceramic casing structural part.

According to the second aspect, an embodiment of the present invention provides a method for preparing a ceramic casing structural part, including the following steps: take ceramic powder, and perform ball-milling to prepare dense ceramic slurry; take more ceramic powder, add a pore-forming agent, and perform ball-milling to prepare porous ceramic slurry; separately dry and then grain the dense ceramic slurry and the porous ceramic slurry, and fill them respectively into a groove in a ceramic casing die corresponding to a ceramic flat plate and a groove in the ceramic casing die corresponding to a ceramic projection to mold them into a ceramic embryo; and then sinter the obtained ceramic embryo to prepare a ceramic casing, where the ceramic casing includes a ceramic flat plate of a dense ceramic material with a density higher than 90% and a ceramic projection of a porous ceramic material, where the ceramic projection is partially embedded in the ceramic flat plate; and take raw materials of a frame and the ceramic casing, and prepare the ceramic casing structural part by using an integrated molding method, where the frame abuts the ceramic flat plate along a thickness direction of the ceramic flat plate by using the ceramic projection, an upper surface and a lower surface of the frame are respectively level with an upper surface and a lower surface of the ceramic casing, and a material of the frame is an alloy, a metal-based composite material, or plastic.

Preferably, the pore-forming agent is selected from one or more of the following: carbon dust, graphite, wood flour, coke, paraffin, and molding powder.

Preferably, the pore-forming agent takes up 20-60% of a total volume of the porous ceramic slurry.

Preferably, the ceramic projection is partially embedded in the frame.

Components of the ceramic powder may be adjusted according to different requirements for product performance, and there is no specific limitation. A main component of the ceramic powder is not limited. Preferably, a main component of the ceramic powder is aluminum oxide or zirconium oxide, and a grain size is of a micron scale or a nanometer scale. The ceramic flat plate is used as an exterior part in this embodiment of the present invention; therefore, to obtain ceramic flat plates with different exterior colors, a dense ceramic material may be formed by mixing other oxides with the ceramic powder, and these other oxides may be selected from but is not limited to yttrium oxide and magnesium oxide; ceramic flat plates with different exterior colors may also be obtained by adding colorants or through sintering in a specific atmosphere, and the ceramic powder may include both aluminum oxide and zirconium oxide

Preferably, polyvinyl alcohol or zirconium xerogel is added as a binder during a ball-milling process. Preferably, a mass of the added binder is 1-15% that of the ceramic powder.

Preferably, distilled water or anhydrous alcohol may also be added as a medium during the ball-milling process, and oleic acid is added as a dispersant, and stearic acid is added as a grinding aid.

Preferably, the graining is preparing particles that pass through a 20-80 mesh screen.

A specific manner of embryo molding is not limited, and may be dry pressing molding, compression molding, isostatic pressing molding, hot die-casting molding, slip casting molding, extrusion molding, roll model molding, injection molding, or in-situ solidification molding, and is preferably dry pressing molding. Preferably, pressure for the dry pressing molding is 15-60 megapascals (MPa).

A specific manner of molding sintering is not limited, and may be pressureless sintering, hot pressing sintering, isostatic pressing sintering, reactive sintering, atmosphere sintering, electric spark sintering, or spark plasma sintering, and is preferably hot pressing sintering. Because a sintering-molded ceramic casing will be placed into a die and pressed in a subsequent operation, the ceramic casing will break if it is not flat. Therefore, flatness of the upper and lower surfaces of the prepared ceramic casing must be ensured during a sintering process. Generally, pressure sintering is used to ensure flatness.

A specific condition of the sintering process is set according to components of the ceramic powder. When a main component of the ceramic powder is aluminum oxide, a sintering condition is preferably: at 150-450° Celsius (C), raising the temperature at a rate of 1 degree centigrade per minute; at 700-950° C., raising the temperature at a rate of 2° C. per minute; after the temperature rises to 1400-1600° C., maintaining it for 2-4 hours, and then obtaining a room temperature through natural cooling. When a main component of the ceramic powder is zirconium oxide, a sintering condition is preferably raising the temperature to 600-700° C. and maintaining it for two hours; then slowly raising the temperature to 1600° C. and maintaining it for two hours; and then obtaining a room temperature through natural cooling.

The ceramic flat plate is not limited in shape or thickness, and may be prepared with various shapes according to actual demands for a product. Preferably, the ceramic flat plate is a rectangular flat plate. The upper and lower surfaces of the ceramic flat plate have proper flatness.

A ceramic projection is not limited in shape or position, and may be partially embedded in a position such as a side face or the lower surface that are of the ceramic flat plate and can contact the frame, where the “can contact the frame” includes a part of the ceramic projection that protrudes from the ceramic flat plate may abut the frame or may be partially or entirely embedded in the frame, with a purpose to fill pores with the frame material by taking advantage of a high porosity of a porous ceramic material of the ceramic projection, thereby increasing a binding force between the ceramic flat plate and the frame. It is understandable that, to increase the binding force, the part of a ceramic projection that protrudes from the ceramic flat plate should contact the frame as much as possible. Preferably, the ceramic projection is partially embedded in the frame.

The integrated molding method includes conventional methods of integrated manufacturing, such as injection molding, injection molding, casting molding, and die-casting molding, and the ceramic casing in the prepared ceramic casing structural part is closely embedded in the frame. A shape of the frame is not limited but depends on an actual demand, and usually includes a bend angle structure. The material of the frame may be an alloy, a metal-based composite material, or plastic. The alloy may be an aluminum alloy, a magnesium alloy, a zinc alloy, or the like, and is preferably an aluminum alloy.

Preferably, when the material of the frame is an alloy, the integrated molding method is die-casting molding, and a specific operation is placing the ceramic casing into a die-casting die cavity for the ceramic casing structural part, and performing die-casting molding with a liquid or semi-solid alloy material to obtain the ceramic casing structural part.

Because the ceramic casing is a compound formed by combining a porous ceramic material and a dense ceramic material to an embryo, and the ceramic projection is of a porous ceramic material. During a process of integrated molding, a liquid or molten alloy material permeates pores of the porous ceramic material, so that the frame is closely combined with the ceramic casing to finally form an integrated ceramic casing structural part.

The method for preparing a ceramic casing structural part provided by the second aspect of the embodiment of the present invention is simple and easy to implement, and is suitable for volume production and application.

### Embodiment 1

A method for preparing a ceramic casing structural part includes the following steps.

(1) Take aluminum oxide ceramic powder with a purity of 99% and a grain size of 0.5-5 microns; add a zirconium xerogel whose mass is 5% that of the aluminum oxide ceramic powder, and add carbon dust as a pore-forming agent; perform ball-milling for two hours to mix them evenly to prepare porous ceramic slurry, where the carbon dust takes up 20% of a total volume of the porous ceramic slurry.

(2) Take more ceramic powder with the following components and weight percentages: Al₂O₃, 96%, purity 99%, and grain size 0.3-3 microns; MgO, 3%, purity 99%, and grain size 0.3-3 microns; Y₂O₃, 1%, purity 98%, and grain size 0.3-3 microns; add polyvinyl alcohol whose mass is 1.5% that of the ceramic powder; and perform ball-milling for two hours to mix them evenly to prepare dense ceramic slurry.

(3) Provide a ceramic casing die, separately dry and then grain the obtained dense ceramic slurry and porous ceramic slurry to prepare particles that pass through a 20-80 mesh screen, then fill the particles respectively into a groove in the ceramic casing die corresponding to a ceramic flat plate and a groove in the ceramic casing die corresponding to a ceramic projection, and perform dry pressing to obtain a ceramic embryo under 40 Mpa.

(4) Place the prepared ceramic embryo into a sintering furnace, at 150-450° C., raise the temperature at a rate of 1 degree centigrade per minute, and at 700-950° C., raise the temperature to 1600° C. at a rate of 2° C. per minute, and maintain it for four hours to prepare a ceramic casing, where pressure is applied to an upper surface and a lower surface of the ceramic embryo during the sintering process to increase smoothness, so that upper and lower surfaces of the ceramic casing have proper flatness, the prepared white ceramic casing includes a ceramic flat plate of the dense ceramic material and a ceramic projection of the porous ceramic material, and the ceramic projection is partially embedded in the ceramic flat plate.

(5) Place the obtained ceramic casing into a die-casting die cavity for the ceramic casing structural part, and then perform die-casting molding with a liquid aluminum alloy material to obtain the ceramic casing structural part.

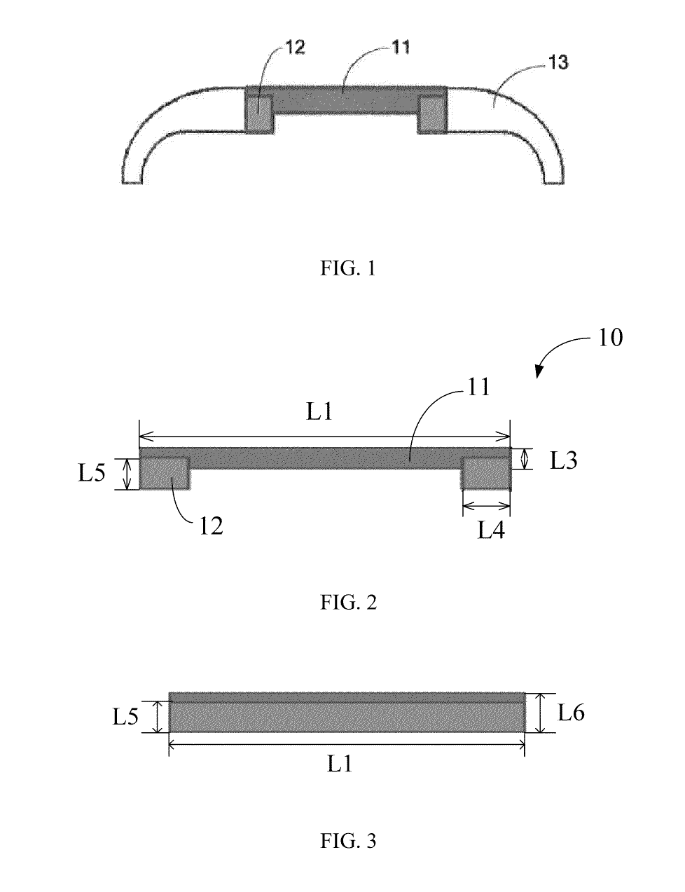

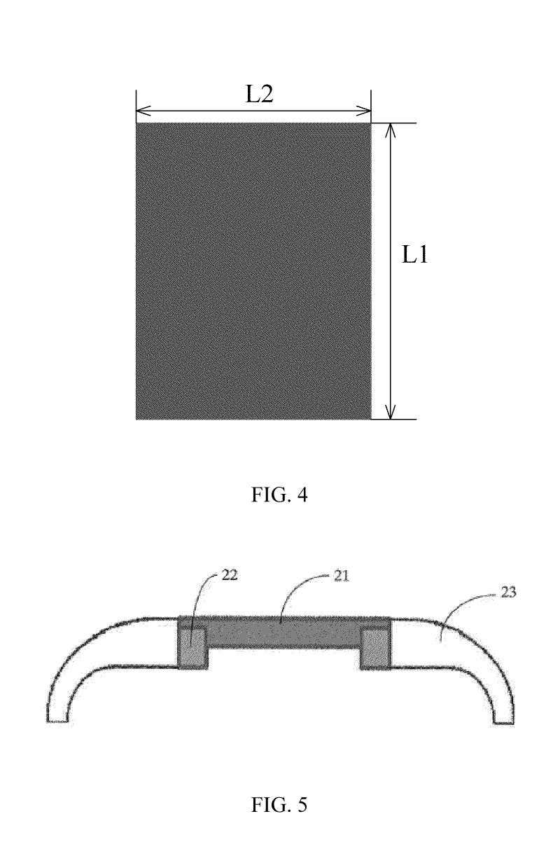

FIG. 1 is a schematic structural diagram of the ceramic casing structural part prepared in Embodiment 1 of the present invention, FIG. 2 is a main view of the ceramic casing prepared in Embodiment 1 of the present invention, FIG. 3 is a right view of the ceramic casing prepared in Embodiment 1 of the present invention, and FIG. 4 is a top view of the ceramic casing prepared in Embodiment 1 of the present invention. With reference to FIG. 1 to FIG. 4, it can be seen that the ceramic casing 10 includes a ceramic flat plate 11 and a ceramic projection 12 that is partially embedded in the ceramic flat plate 11. In this embodiment, the ceramic flat plate 11 is a rectangular flat plate, the number of disposed ceramic projections 12 is two, and the ceramic projections 12 are disposed symmetrically and vertical to the ceramic flat plate 11, and the ceramic flat plate 11 abuts an aluminum alloy frame 13 by using the ceramic projections 12. In this embodiment, a part of a ceramic projection 12 that protrudes from the ceramic flat plate 11 abuts the frame 13 along a thickness direction of the ceramic flat plate 11. A length L1 of the ceramic flat plate 11 is equal to 100 millimeters (mm), a width L2 of the ceramic flat plate 11 is equal to 60 mm, and a height L3 of the ceramic flat plate 11 is equal to 0.8 mm; the two ceramic projections 12 are vertically and symmetrically disposed at edges of a lower surface of the ceramic flat plate 11. A ceramic projection 12 is a square column structure, a length of the ceramic projection 12 is the same as the length of the ceramic flat plate 11, a width L4 of the ceramic projection 12 is 1.2 mm, and a height L5 of the ceramic projection 12 in a direction vertical to the ceramic flat plate 11 is 1.2 mm. In the interior of a ceramic projection 12, there are a large number of porous structures (which are not shown in the figures) with apertures of 1-1200 microns, and the pores are filled with an aluminum alloy material. An upper surface and a lower surface of the ceramic casing 10 are respectively level with an upper surface and a lower surface of the aluminum alloy frame 13, that is, a height L6 of the ceramic casing 10 is equal to a height of the aluminum alloy frame 13, and both are 1.4 mm.

### Embodiment 2

A method for preparing a ceramic casing structural part includes the following steps.

(1) Take yttrium oxide toughened zirconium oxide ceramic powder, that is, a 7YSZ material, where a grain size is 0.5-3 microns and a mass of yttrium oxide is 7% that of the ceramic powder, add graphite with a grain size of 3-6 microns, and then add an aqueous polyvinyl alcohol solution whose mass is 5% that of the 7YSZ material; perform ball-milling for 2 hours to mix them evenly to prepare porous ceramic slurry, where the graphite takes up 40% of a total volume of the porous ceramic slurry.

(2) Take more yttrium oxide toughened zirconium oxide ceramic powder, that is, a 7YSZ material, where a grain size is 0.5-3 microns and a mass of yttrium oxide is 7% that of the ceramic powder, add a cobalt black colorant (which is synthesized by Co—Cr—Fe—Ni oxide at a high temperature) to the zirconium oxide ceramic powder to obtain a mixture, and use the mixture as ceramic powder, where the cobalt black colorant takes up 5% of the total mass of the ceramic powder; add an aqueous polyvinyl alcohol solution whose mass is 5% that of the ceramic powder; and perform ball-milling for 2 hours to mix them evenly to prepare dense ceramic slurry.

(3) Provide a ceramic casing die, separately dry and then grain the obtained dense ceramic slurry and porous ceramic slurry to prepare particles that pass through a 20-80 mesh screen, then fill the particles respectively into a groove in the ceramic casing die corresponding to a ceramic flat plate and a groove in the ceramic casing die corresponding to a ceramic projection, and perform dry pressing to obtain a ceramic embryo under 60 Mpa.

(4) Place the prepared ceramic embryo into a sintering furnace, raise the temperature to 650° C., and maintain it for 2 hours, and then raise the temperature to 1600° C. at a rate of 2° C. per minute, and maintain it for 2 hours to prepare a black ceramic casing, where pressure is applied to an upper surface and a lower surface of the ceramic embryo during the sintering process to increase smoothness, so that upper and lower surfaces of the ceramic casing have proper flatness, the prepared white ceramic casing includes a ceramic flat plate of the dense ceramic material and a ceramic projection of the porous ceramic material, and the ceramic projection is partially embedded in the ceramic flat plate.

(5) Place the obtained ceramic casing into a die-casting die cavity for the ceramic casing structural part, and then perform die-casting molding with a liquid aluminum alloy material to obtain the ceramic casing structural part.

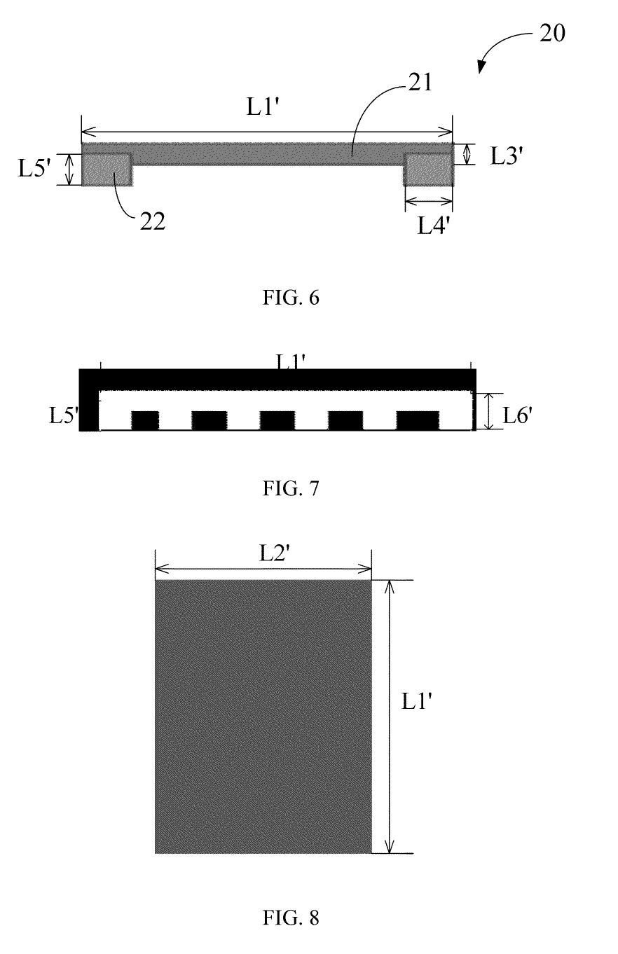

FIG. 5 is a schematic structural diagram of the ceramic casing structural part prepared in Embodiment 2 of the present invention, FIG. 6 is a main view of the ceramic casing prepared in Embodiment 2 of the present invention, FIG. 7 is a right view of the ceramic casing prepared in Embodiment 2 of the present invention, and FIG. 8 is a top view of the ceramic casing prepared in Embodiment 2 of the present invention. With reference to FIG. 5 to FIG. 8, it can be seen that the ceramic casing 20 includes a ceramic flat plate 21 and a ceramic projection 22 that are partially embedded in the ceramic flat plate 21. In this embodiment, the ceramic flat plate 21 is a rectangular flat plate, the number of disposed ceramic projections 22 is 12, and the ceramic projections 22 are disposed symmetrically and vertical to the ceramic flat plate 21, and the ceramic flat plate 21 abuts an aluminum alloy frame 23 by using the ceramic projections 22. In this embodiment, a part of a ceramic projection 22 that protrudes from the ceramic flat plate 21 abuts the frame 23 along a thickness direction of the ceramic flat plate 21. A length L1′ of the ceramic flat plate 21 is equal to 100 mm, a width L2′ of the ceramic flat plate 21 is equal to 60 mm, and a height L3′ of the ceramic flat plate 21 is equal to 0.8 mm; the twelve ceramic projections 22 are disposed symmetrically with intervals at edges of a lower surface of the ceramic flat plate 21, and are square column structures, where a width L4′ of a ceramic projection 22 is 1.2 mm, and a height L5′ of a ceramic projection 22 in a direction vertical to the ceramic flat plate 21 is 1.2 mm. In the interior of a ceramic projection 22, there are a large number of porous structures (which are not shown in the figures) with apertures of 1-1200 microns, and the pores are filled with an aluminum alloy material. An upper surface and a lower surface of the ceramic casing 20 are respectively level with an upper surface and a lower surface of the aluminum alloy frame 23, that is, a height L6′ of the ceramic casing 20 is equal to a height of the aluminum alloy frame 23, and both are 1.4 mm.

What is claimed is:

1. A ceramic casing structural part, comprising:
a ceramic casing; and
a frame,
wherein the ceramic casing comprises a ceramic flat plate and a ceramic projection that is partially embedded in the ceramic flat plate, the frame abuts the ceramic flat plate along a thickness direction of the ceramic flat plate by using the ceramic projection, an upper surface and a lower surface of the frame are respectively level with an upper surface and a lower surface of the ceramic casing, a material of the ceramic flat plate is a dense ceramic material with a density higher than 90%, a material of the ceramic projection is a porous ceramic material, and a material of the frame is an alloy, a metal-base composite material, or plastic.

2. The ceramic casing structural part according to claim 1, wherein a porosity of the porous ceramic material is 20-60%, and a pore size is 1-1200 microns.

3. The ceramic casing structural part according to claim 1, wherein the dense ceramic material is an aluminum oxide-based ceramic or a zirconium oxide-based ceramic, and a grain size of the aluminum oxide and the zirconium oxide is of a micron scale or a nanometer scale.

4. The ceramic casing structural part according to claim 1, wherein the porous ceramic material is an aluminum oxide-based ceramic or a zirconium oxide-based ceramic, and a grain size of the aluminum oxide and the zirconium oxide is of a micron scale or a nanometer scale.

5. The ceramic casing structural part according to claim 1, wherein the ceramic projection is partially embedded in the frame.

6. A method for preparing a ceramic casing structural part, comprising:
taking ceramic powder;
performing ball-milling to prepare dense ceramic slurry;
taking more ceramic powder, adding a pore-forming agent, and performing ball-milling to prepare porous ceramic slurry;
separately drying and then graining the dense ceramic slurry and the porous ceramic slurry;
filling them respectively into a groove in a ceramic casing die corresponding to a ceramic flat plate and a groove in the ceramic casing die corresponding to a ceramic projection to mold them into a ceramic embryo;
sintering the obtained ceramic embryo to prepare a ceramic casing, wherein the ceramic casing comprises a ceramic flat plate of a dense ceramic material with a density higher than 90% and a ceramic projection of a porous ceramic material, wherein the ceramic projection is partially embedded in the ceramic flat plate; and
taking raw materials of a frame and the ceramic casing, and preparing the ceramic casing structural part by using an integrated molding method, wherein the frame abuts the ceramic flat plate along a thickness direction of the ceramic flat plate by using the ceramic projection, an upper surface and a lower surface of the frame are respectively level with an upper surface and a lower surface of the ceramic casing, and a material of the frame is an alloy, a metal-based composite material, or plastic.

7. The method for preparing the ceramic casing structural part according to claim 6, wherein when the material of the frame is an alloy, the integrated molding method is die-casting molding, and a specific operation comprises placing the ceramic casing into a die-casting die cavity for the ceramic casing structural part, and performing die-casting molding with a liquid or semi-solid alloy material to obtain the ceramic casing structural part.

8. The method for preparing the ceramic casing structural part according to claim 6, wherein the pore-forming agent is selected from one or more of the following: carbon dust, graphite, wood flour, coke, paraffin, and molding powder.

9. The method for preparing a ceramic casing structural part according to claim 6, wherein the pore-forming agent takes up 20-60% of a total volume of the porous ceramic slurry.

10. The method for preparing a ceramic casing structural part according to claim 6, wherein a main component of the ceramic powder is aluminum oxide or zirconium oxide, and a grain size of the aluminum oxide and the zirconium oxide is of a micron scale or a nanometer scale.

11. The method for preparing a ceramic casing structural part according to claim 6, wherein the ceramic projection is partially embedded in the frame.
